(19) United States
(12) Patent Application Publication
(10) Pub. No.: US 2025/0270351 A1
(43) Pub. Date: Aug. 28, 2025

(54) FLUOROPOLYMER PREPARATION AT LOW TEMPERATURE

(71) Applicant: Arkema Inc., King of Prussia, PA (US)

(72) Inventors: Caiping LIN, King of Prussia, PA (US); Dane FOX, King of Prussia, PA (US); Qing LI, King of Prussia, PA (US)

(21) Appl. No.: 18/704,952

(22) PCT Filed: Oct. 25, 2022
(86) PCT No.: PCT/US2022/047640

§ 371 Date: Apr. 26, 2024

Related U.S. Application Data
(60) Provisional application No. 63/273,196, filed on Oct. 29, 2021.

(51) Int. Cl. C08F 14/22

(52) U.S. Cl. CPC C08F 14/22; C08F 2800/10

(57) ABSTRACT

The polymerization of vinylidene fluoride at low reaction temperature in the presence of reducing agents especially Bruggolite® type Sulfinate, sulfonate, and sulfite reducing agents, combined with an inorganic initiator resulting in a predominately β phase fluoropolymer is disclosed.

### FIELD OF THE INVENTION

The invention relates to polyvinylidene fluoride polymers having β phase crystals and their preparation. More particularly, it related to a specific method to prepare a polymer with specific properties.

### BACKGROUND

Typically, VDF-based polymers are produced via aqueous polymerization (typical emulsion polymerization) processes, by reacting a polymerization initiator in the presence of the fluorinated monomers and of at least one surfactant (also referred to as emulsifier). High reaction temperature is required in emulsion polymerization due to thermal degradation requirement for both inorganic persulfate initiator and organic peroxide initiator. Using redox initiator systems contain a peroxide such as t-butyl hydrogen peroxide and metal oxidizer in emulsion polymerization can bring the reaction temperature to middle range, but they usually contain a coupling/accelerant agent between the oxidizer and the reducer and require a surfactant, such as fluorosurfactant.

U.S. Pat. No. 20,020,42353 discloses sulfinic acids compounds that can be used as a reducing agent.

WO2019/002180 discloses the use of sulfinic acid compounds as reducing agent in the presence of organic peroxide for the synthesis of fluoropolymers using micro-emulsion polymerization which is based on fluorosurfactant.

Polyvinylidene fluoride is a polymer that can crystallize into multiple phases with different chain conformations known as α, β, γ, and ε phase. The β phase has strong ferroelectric and piezoelectric properties because of its planar conformation and high dipole density.

PVDF attracted a lot of interest in a flexible piezoelectric material due to its piezoelectric properties, which originate from the polar β crystal conformation of its crystalline structure. A high proportion of the β phase in PVDF can be prepared via tailoring the polymer chain structure and though a second processing process. Tailoring polymer chains structure can be achieved through copolymerization of vinylidene fluoride with some co monomer such as vinyl fluoride (VF), Trifluoroethylene (TrFE), chlorotrifluoroethylene (CTFE). Second processing process include post treatment techniques such as temperature, pressure, cooling rate and by applying a shearling forces; or addition of additives such as carbon nanotubes, ferrite particles and clay.

Previous art/methods to produce ferroelectric β phase PVDF rely on combinations of annealing, controlled solvent evaporation, and uni-axial stretching of a samples. These methods requires a second expensive and tough processing after material synthesized.

There exists a need to run the polymerization at lower the reaction temperatures. Persulfate initiators by themselves will not work effectively under 50° C. Low temperature reaction is desirably as it reduces the reverse units and increases melting temperature and percent crystallinity.

Surprisingly, the Applicant found that by conducting an emulsion polymerization process at a temperature of less than 70° C., preferably less than 65° C., comprising the reaction of at least one unsaturated fluorinated monomer in the presence of a redox-initiating system comprising at least one inorganic peroxide and at reducing agent bearing a sulfinic acid group, a polymer containing β phase crystalline structure can be obtained

This invention discloses a redox system that operates at low temperature, without a coupling agent/accelerant agent and surfactant, yet provides vinylidene fluoride based fluoropolymer with high melting point, high heat of fusion (first heating in DSC) and having a majority portion of the crystalline phase as β phase.

The present invention provides for high melting temperature, reverse units percentage of between 3.2 to 4.2% and a high heat of fusion and the presence of β phase crystals that form during the polymerization process.

### DESCRIPTION OF THE FIGURES

FIG. 1 is a wide angle X-ray diffraction of PVDF prepared in this invention (for β phase). (β phase presents a well define peak at 2θ=20.26∘ relative to the sum of the diffraction from (1 1 0) and (2 0 0) planes).

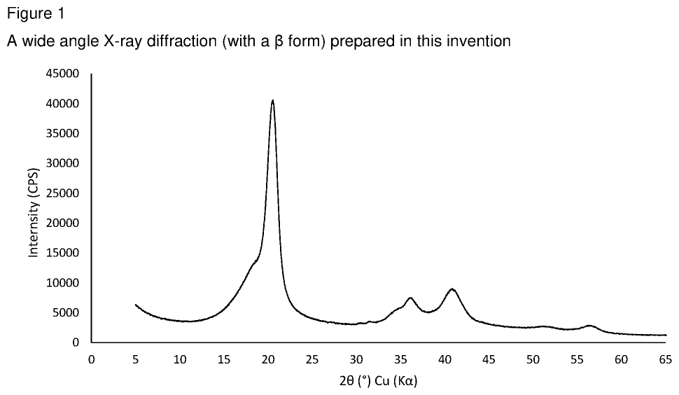

### SUMMARY OF INVENTION

The invention provides a method of making a VDF based fluoropolymer. The method for the synthesis of a fluorinated polymer comprising recurring units derived from vinylidene fluoride, said method comprises polymerizing vinylidene fluoride, optionally in the presence of at least one further acrylic comonomer, in an aqueous emulsion, at temperature of below 70° C., preferably in a temperature range of from 1 to 65° C., in the presence of a redox-initiating system comprising at least one inorganic initiator and at least one reducing agent, said reducing agent comprising at least one compound bearing a sulfinic acid group.

The Applicant surprisingly found that the method according to the present invention allows the manufacture of a VDF-based polymer directly from the polymerization process characterized by high melting temperature, high heat of fusion in the 1 st cycle, and predominately β phase as measured by the intensity ratio (I_{β(200/110)}/[I_{α(020)}+I_{γ(020)}]) using x-ray diffraction of greater than 10.

In one embodiment, the invention provides a PVDF homopolymer or PVDF/acrylic copolymer having unexpected properties. These properties comprises: a) very high melting temperature of 170° C. or greater, preferably 172° C. to 180° C.; b) high heat of fusion, greater than 65 J/g upon the 1 st heating process in DSC; C) β phase crystal peak intensity ratio: I_{β(200/110)}/[I_{α(020)}+I_{γ(020)}] of greater than 10. The β phase crystal peak intensity ratio equals I_{β(200/110)}/[I_{α(020)}+I_{γ(020)}]

In another embodiment, the method of the present invention comprises polymerizing vinylidene fluoride with at least one further monomer as defined herein, in an aqueous emulsion in the presence of the reducing agent as defined herein, and optionally further ingredients.

The present invention also relates to a fluorinated polymer comprising recurring units derived from vinylidene fluoride, and optionally recurring units derived from at least one further co monomer, said polymer being advantageously obtained via the above mentioned method.

The invention describes a process/method for making vinylidene fluoride based polymer at low temperature using reducing agents especially Bruggolite® type Sulfinate, sulfonate, and sulfite reducing agents, combined with an inorganic initiator such as hydrogen peroxide, potassium persulfate, ammonium persulfate or sodium persulfate.

### ASPECTS OF THE INVENTION

Aspect 1: A polyvinylidene fluoride polymer comprising recurring units derived from at least 97 mol percent vinylidene fluoride, optionally from 0 to 3 mol % acrylic comonomer, in an aqueous emulsion wherein the polymer has a β phase crystal peak intensity ratio of greater than 10, preferable greater than 15, preferable greater than 20, and a heat of fusion (1^{st} heating) of greater than 65 J/g and a melting temperature of between 170° C. and 180° C.

Aspect 2: A method for the synthesis of a fluorinated polymer comprising recurring units derived from vinylidene fluoride, said method comprising polymerizing vinylidene fluoride monomer, optionally in the presence of at least one acrylic comonomer, in an aqueous emulsion in a temperature range of from 1° C. to 65° C., in the presence of a redox-initiating system comprising at least one inorganic initiator and at least one reducing agent having a sulfinic group and wherein the resulting polymer has a β phase crystal peak intensity ratio of greater than 10.

Aspect 3: The method of aspect 2 wherein the at least one reducing agent comprises the formula (I):

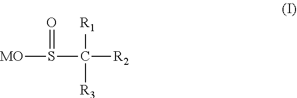

where; M is a hydrogen atom, an ammonium ion, a monovalent metal ion or an equivalent of a divalent metal ion of the groups Ia, IIa, IIb, IVa or VIIIb of the Periodic Table of the Elements; R1 is OH, wherein R2 is H or an alkyl group, alkenyl group, cycloalkyl group or aryl group, optionally these groups have 1, 2 or 3 substituents which are chosen independently of one another from C₁-C₆ alkyl, OH, O—(C₁-C₆ alkyl), and R3 is COOM, SO₃M, or COOR2, where M and R2 are as defined above,

Aspect 4: The method according to Aspect 2 or 3, wherein said inorganic initiator is selected from the group consisting of hydrogen peroxide and inorganic persulfates (such as potassium persulfate, ammonium persulfate and sodium persulfate); and combinations thereof.

Aspect 5: The method according to any one of aspects 2 to 4, wherein said inorganic initiator is used at a concentration ranging from 0.01 to 4 wt % based on the total VDF added to the reaction.

Aspect 6: The method according to any one of aspects 2 to 5, wherein said inorganic initiator is selected in the group consisting of potassium persulfate, ammonium persulfate, sodium persulfate and combinations thereof.

Aspect 7: The method according to any one of aspects 2 to 6 wherein the temperature range is from 5° C. to 65° C., preferably from 5° C. to 55° C.

Aspect 8: The method according to any one of aspects 2 to 6 wherein the temperature range is from 20 to 63° C., preferably from 20 to 60° C.

Aspect 9: The method according to any one of aspects 2 to 8, wherein said fluorinated polymer comprises at least 97 mole percent, more preferably at least 98% mole percent, and even more preferably at least 99% mole percent, of recurring units derived from vinylidene fluoride with respect to all recurring units of said fluorinated polymer.

Aspect 10: The method according to any one of aspects 2 to 9, wherein said fluorinated polymer is a homopolymer.

Aspect 11: The method according to any one of aspects 2 to 9, wherein said fluorinated polymer is a co-polymer which comprises recurring units derived from vinylidene fluoride and recurring units derived from at least one acrylic comonomer.

Aspect 12: The method according to any one of aspects 2 to 9 or 11, wherein the co monomer can be represented by the formula:

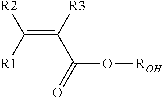

wherein each of R1, R2, R3, equal or different from each other, is independently a hydrogen atom or a C1-C3 hydrocarbon group, and ROH is a hydrogen or a C1-C5 hydrocarbon moiety.

Aspect 13: The method according to any one of aspects 2 to 9 or 11 to 12, wherein at least one co monomer is selected from the group consisting of acrylic acid, methacrylic acid, hydroxyethyl(meth)acrylate, hydroxypropyl(meth)acrylate; and hydroxyethylhexyl(meth)acrylate.

Aspect 14: The method according to any one of aspects 2 to 13, wherein the polymer β phase crystal peak intensity ratio is greater than 15, preferably greater than 20.

Aspect 15: The method according to any one of aspects 2 to 14, wherein the fluorinated polymer has a melting point of between 170 and 180 C.

Aspect 16: The method according to any one of aspects 2 to 15, wherein the fluorinated polymer has a heat of fusion (1^{st} heating) of greater than 65 J/g, preferable greater than 70 J/g.

Aspect 17: The method according to any one of aspects 2 to 16, wherein the fluorinated polymer has reverse units percentage of between 3.2 to 4.2% as measure by ¹⁹F-NMR.

Aspect 18: The method according to any one of aspects 3 to 17, wherein said reducer further comprises formula (II):

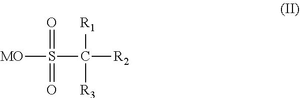

wherein M is a hydrogen atom, an ammonium ion, a monovalent metal ion; R₁ is —OH where R₂ is hydrogen atom, a linear or a branched alkyl group having from 1 to 6 carbon atoms, 5- or 6-membered cycloalkyl group, or 5- or 6-membered aryl group; R3 is —COOM, —SO₃M, or —COOR2, wherein M and R2 are as defined above, and salts thereof with at least one monovalent metal ion; Preferably, M is hydrogen atom or a monovalent metal ion;
Preferably, said monovalent metal ion is selected from sodium and potassium;
Preferably, R2 is selected from hydrogen atom, linear alkyl group having from 1 to 3 carbon, branched alkyl group having from 1 to 3 carbon atoms, or 5- or 6-membered aryl group.

Aspect 19: The polyvinylidene fluoride polymer of aspect 1, wherein the polymer has a β phase crystal peak intensity ratio of greater than 30.

Aspect 20: The polymer made by the method of any one of claims 2 to 18.

Aspect 21: Use of the polymer made by the method of any one of aspects 2 to 18 in a battery.

### DETAILED DESCRIPTION OF THE INVENTION

Unless stated otherwise, all percentages, parts, ratios, etc. are by weight

The invention provide a suitable method to prepare fluoropolymer from fluoromonomer. The fluoropolymers are prepared in an aqueous polymerization reaction mixture that includes an inorganic iniator, preferably persulfate, and one or more sulfinic acid derivative reducers. Optionally, polymerizations to prepare the fluoropolymers may be performed in the presence of chain transfer agents to regular molecular weight, buffering agents to maintain a desired pH range during the polymerization, and antifoulants to reduce or eliminate adhesion of the polymer to the inside surfaces of the polymerization vessels. The invention also provides methods for preparing fluoropolymers having unique properties. The unique properties including, not limit to, high melting point, high heat of fusion (in 1 st heating cycle) and predominate β phase crystal structure.

The fluoropolymers refers to homopolymers and to copolymers having functional acrylic comonomers containing less than 3 mole percent of acrylic comonomer units based on the total monomer units in the polymer, preferably less than 2 mole %, and preferably less than 1 mole %. Generally the amount of acrylic comonomer is greater than 0.01 wt %. The copolymers formed may be homogeneous or heterogeneous, and may have a controlled architecture such as star, branch random or block copolymers.

The vinylidene fluoride based polymers of the invention are conveniently made by aqueous polymerization, preferably emulsion polymerization using a redox initiation system. The polymerization process can be a batch, semi-batch or continuous polymerization process.

The polymerization process preferably contains no other fluorine containing compounds or molecules except for the monomers and the resulting polymerization products. No fluorinated surfactant is used.

The following general procedure may be followed: to a reactor is initially added deionized water without a dispersion agent, optionally, a chain transfer agent, an antifoulant and a buffering agent, followed by deoxygenation (removal of oxygen). After the reactor reaches the desired temperature, vinylidene fluoride and optional an acrylic comonomer is added to the reactor to reach a predetermined pressure. When the desired reaction pressure is reached, an oxidant and a reducing agent are added to start and maintain the reaction. After reaching the desired solid level, the feed of the monomers can be stopped. However, the charging of initiator can be stopped or continued to consume the unreacted monomers. After the initiator charging is stopped, the reactor may be cooled and agitation stopped. The unreacted monomers can be vented and the prepared copolymer can be collected through a drain port or by other collection means.

The reactor used in the polymerization is a pressurized polymerization reactor. The reactor usually is equipped with a stirrer and heat control means. The stirring may be constant, or may be varied to optimize process conditions during the course of the polymerization. The method according to the present invention can be preferably performed in continuous, or semi-batch or batch.

The temperature of the polymerization is typically from 1° C. to 65° C., preferably of 5° C. to 65° C. or from 20° C. to 60° C., or from 5° C. to 55° C. The temperature can be varied during the reaction, preferably the temperature is kept constant at +/−0.5° C. The temperature of the polymerization is typically above 1° C., above 5° C., or above 20° C. and typically below 65° C., below 60° C. or below 55° C.

The pressure of the polymerization may vary from 1380 to 12,500 kPa, depending on the capabilities of the reaction equipment, the initiator system chosen, and the monomer selection. The polymerization pressure is preferably from 2,000 to 9,000 kPa, and most preferably from 3,500 to 5,500 kPa.

In general, the reaction time is preferably under 150 minutes, preferably under 120 minutes, more preferably under 100 minutes. In general, the reaction time is preferably at least 30 minutes.

Advantageously, the method of the present invention comprises polymerizing vinylidene fluoride in the presence of a redox-initiating system comprising at least one inorganic initiator (oxidant) and at least one composition comprising at least one compound bearing at least one sulfinic acid group (reducing agent), and optionally further ingredients.

### Oxidant

The reaction is started and maintained by the addition of an inorganic radical initiator particularly inorganic peroxides. The present invention preferably uses inorganic persulfate as the initiator.

Organic peroxides are not used in the present invention. Organic peroxides require the presence of a surfactant, preferably fluorosurfactant and a catalyst to obtain a good reaction rate.

Preferably, said inorganic radical initiator is selected from the group comprising, hydrogen peroxide, persulfates (such as potassium persulfate, sodium persulfate and ammonium persulfate), preferably potassium persulfate in conjunction with sodium acetate or sodium acetate trihydrate.

Typical inorganic persulfates (sodium, potassium or ammonium persulfate), have useful activity in the 65° C. to 105° C. temperature range. However, a “Redox” system can operate at even lower temperatures and examples include combination of oxidants such as hydrogen peroxide, or inorganic persulfate, and reductants such as Sulfinate, sulfonate, and/or sulfite reducing agents, such as Bruggolite® type reducing agents.

The total amount of inorganic initiator used is from 0.01% to 4.0 wt %, more preferable from 0.1%-3wt%, based on the total monomer weight used. A mixture of one or more inorganic initiators as defined above, can be used to conduct the polymerization at a desirable rate. Typically, sufficient initiator is added at the beginning to start the reaction and then additional initiator may be optionally added to maintain the polymerization at a convenient or desired rate.

### Reducing Agent

The reducing agent comprises at least one compound bearing at least one sulfinic acid group. (“sulfinic acid compound”). Descriptions of such reducing agents can be found in US 2002/0042353 which is herein incorporated by reference.

The reducing agent is a composition comprising at least Formula I, and optionally Formula II and optionally Formulas III. The reducing agent composition comprises at least 30% by weight of Formula I.

The reducing agent is not fluorinated.

Formula I is represented by the formula:

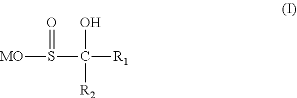

In Formula I; M is a hydrogen atom, an ammonium ion, a monovalent metal ion or an equivalent of a divalent metal ion of the groups Ia, IIa, IIb, IVa or VIIIb of the Periodic Table of the Elements; where R₁ is H, an alkyl group, alkenyl group, cycloalkyl group or aryl group, it being possible for these groups to have 1, 2 or 3 substituents which are chosen independently of one another from C₁-C₆-alkyl, OH, O—C₁-C₆-alkyl, and R₂ is COOM, SO₃M, or COOR5, where M is as defined above and R5 is H or a linear or branched alkyl chain having 1 to 6 carbons.

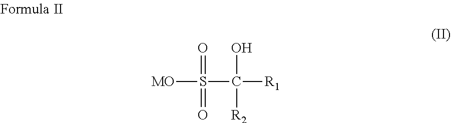

In Formula II, M is a hydrogen atom, an ammonium ion, a monovalent metal ion; where R₁ is hydrogen atom, linear alkyl group having from 1 to 6 carbon atoms, branched alkyl group having from 1 to 6 carbon atoms, 5- or 6-membered cycloalkyl group, or 5- or 6-membered aryl group; R2 is —COOM, —SO₃M, or —COOR5, wherein R5 is H or a linear or branched alkyl chain having 1 to 6 carbons and M is as defined above, and salt thereof with at least one monovalent metal ion. Preferably, M is hydrogen atom or a monovalent metal ion. Preferably, said monovalent metal ion is selected from sodium and potassium. Preferably, R2 is selected from hydrogen atom, linear alkyl group having from 1 to 3 carbon atoms, branched alkyl group having from 1 to 3 carbon atoms, and 5- or 6-membered aryl group. Preferably, R3 is selected from —COOM, —SO₃M, and COOR5.

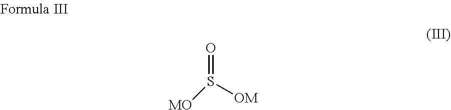

In Formula III, M is a hydrogen atom, an ammonium ion, a monovalent metal ion, preferably Na₂SO₃

Suitable examples of said reducing agents are commercially available from BRUGGEMANN-GROUP under the trade name Bruggolite®.

The reducing agent is used in an amount of from 0.01% to 4.0 wt %, more preferable from 0.1%-3%, by weight based on the total monomer weight used.

### Surfactant

The method of the present invention is performed in the absence of a surfactant.

### Chain Transfer Agent

A chain-transfer agent may be added to the polymerization to regulate the molecular weight of the product. They may added to a polymerization in a single portion at the beginning of the reaction, or incrementally or continuously throughout the reaction. The amount and mode of addition of chain-transfer agent depend on the activity of the particular chain-transfer agent employed, and on the desired molecular weight of the polymer product. The amount of chain-transfer agent added to the polymerization reaction is from about 0 to 5 wt %, preferably 0.05 to about 5 weight percent, more preferably from about 0.1 to about 2 weight percent based on the total weight of monomer added to the reaction mixture. Examples of chain transfer agents useful in the present invention include, but are not limited to: oxygenated compounds such as alcohols (preferably having 3 to 10 carbons), carbonates, ketones, esters, and ethers may serve as chain-transfer agents such as acetone, ethylacetate, diethylether, methyl-ter-butyl ether, isopropyl alcohol; bis(alkyl)carbonates wherein the alkyl has from 1 to 5 carbon atoms, such as bis(ethyl)carbonate, bis(isobutyl)-carbonate; ethane, propane.

A paraffin antifoulant may be employed, if desired, although it is not preferred, and any long-chain, saturated, hydrocarbon wax or oil may be used. Reactor loadings of the paraffin may be from 0.01% to 0.3% by weight on the total monomer weight used.

### Monomers

The major monomer (meaning greater than 97 wt % of the polymer) used in this invention is vinylidene fluoride. Other ethylenically unsaturated monomers may be present. The term “fluoropolymer” means a polymer formed by the polymerization of vinylidene fluoride and optionally (meth)acrylic comonomer, and it is inclusive of homopolymers, copolymers, terpolymers and higher polymers which are thermoplastic in their nature, meaning they are capable of being formed into useful pieces by flowing upon the application of heat, such as is done in molding and extrusion processes. The fluoropolymer contains at least 97 weight percent of vinylidene fluoride. The thermoplastic polymer exhibits a crystalline melting point.

The optional (meth)acrylic comonomer can be represented by the formula:

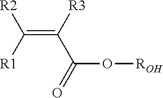

wherein each of R1, R2, R3, equal or different from each other, is independently a hydrogen atom or a C1-C3 hydrocarbon group, and ROH is a hydrogen or a C1-C5 hydrocarbon moiety. Non limitative examples of the (meth)acrylic monomers are acrylic acid, methacrylic acid, hydroxyethyl(meth)acrylate, hydroxypropyl(meth)acrylate; hydroxyethylhexyl(meth)acrylates; acrylic esters such as alkyl(meth)acrylates; vinyl esters such as vinyl acetate, vinyl propionate, vinyl butyrate. Preferably R1, R2, R3 are hydrogen.

### Buffering Agent

The polymerization reaction mixture may optionally contain a buffering agent to maintain a controlled pH throughout the polymerization reaction. The pH is preferably controlled within the range of from about 4 to about 8, to minimize undesirable color development in the product.

Buffering agents may comprise an organic or inorganic acid or alkali metal salt thereof, or base or salt of such organic or inorganic acid, that has at least one pKₐ value and/or pK_{b} value in the range of from about 4 to about 10, preferably from about 4.5 to about 9.5. Preferred buffering agents in the practice of the invention include, for example, phosphate buffers and acetate buffers. A “phosphate buffer” is a salt or salts of phosphoric acid. An “acetate buffer” is a salt of acetic acid.

The dispersion obtained from the polymerization of the invention has a solids level of from 10 to 50 weight percent, preferably from 15-40 weight percent. The fluoropolymer particles in the dispersion have a primary particle size in the range of 50 to 600 nm, and preferable from 100-500 nm.

The polymer or copolymer can be isolated using standard methods such as oven drying, spray drying, shear or acid coagulation followed by drying, or kept in the aqueous media for subsequent application or use.

In a further aspect, the present invention also relates to an article made from a composition comprising at least polymer as defined above.

In a further aspect, the present invention relates to a method for the manufacture of shaped article, said method comprising processing a composition comprising at least polymer as defined above.

Said polymer can be fabricated, e.g. by moulding (injection moulding, extrusion moulding), calendering, or extrusion, into the desired shaped article. If necessary, the article is then subjected to vulcanization (or curing) during the processing itself and/or in a subsequent step (post-treatment or post-cure).

### Characteristics of the Polymer

The resulting polymer is thermoplastic.

The novel polymerization method provide for a novel polymer composition. The composition comprises a PVDF copolymer. PVDF polymer is melt processable.

The polymer is preferably not crosslinked.

The PVDF polymer comprises at least 97 wt % VDF, preferably at least 98 wt % by weight VDF. The PVDF polymer comprises up to 100 weight percent VDF.

The PVDF homopolymer and PVDF copolymers of the invention are characterized in that they have a melting temperature of between 170° C. and 180° C., preferably from 171° C. to 178° C. (ASTM D3418) measured in DSC.

The inventive polymer has reverse units percentage of between 3.2 to 4.2% as measure by ¹⁹F-NMR.

The inventive polymer has a heat of fusion (ASTM D3418) of greater than 65 J/g, preferable greater than 70 J/g, measured in DSC, upon the heating process.

The polymers made according to this invention contain a measurable level of crystalline polyvinylidene fluoride, such as may be indicated by the presence of a crystalline melting point in a differential scanning calorimetry (DSC) experiment. The melting temperature is assigned to peak of endotherm in the second cycle. The heat of fusion is determine in the first cycle. The DSC scan measuring the crystalline content is performed according to ASTM standard D3418. The DSC run is performed in a three step cycle. The cycle begun at −20° C., followed by 10° C./min ramp to 210° C., with a 10 minute hold, the sample is then cooled at rate of 10° C./min to −20° C., and then reheated at the 10° C./min to 210° C.

The present invention provides a polymer having predominately β phase crystallinity. The polymer has a β phase crystal peak intensity ratio, defined as I_{β(200/110)}/[I_{α(020)}+I_{γ(020)}], is greater than 10. The β phase crystal peak intensity ratio for the polymer of the invention preferably is greater than 15, or greater than 20, or greater than 30, or greater than 40, or greater than 45 as measured using X-ray diffraction as described in the examples.

The present invention provides polyvinylidene fluoride with rich β phase surpassing the prior art such as copolymerization methods and second processing methods.

The melt viscosity of the inventive polymer is generally in the range of from 5 to 75, preferably 35 kPoise to 75 kPoise, more preferably from 35 to 65 kPoise (ASTM D3835 at 232° C. and 100 sec−1)

The polymer of the present invention has application in the fabrication of high performance and low cost actuators applications.

### EXAMPLES

### Examples 1-4

The experiments were carried out in a 1.7 L stainless steel reactor in which were added 1000 g of water. The reactor was purged with nitrogen gas. The reactor was sealed and agitation is started at 72 RPM. 72 RPM agitation was maintained throughout the whole reaction. The reactor was heated to desired temperature. The reactor was charged with vinylidene fluoride to reach the desired pressure of 4500 kPa. After pressurization, the reactor was charged with initiator solution and a reducing agent solution. Initiator solution was aqueous initiator solution of 1% potassium persulfate (from EMD Chemicals, ACS grade). A reducing agent solution is 1% FF6M (Bruggolite) solution. A continuous feed of the aqueous initiator solution and the reducing agent solution was added to the reaction to obtain adequate polymerization rate. The reaction temperature was held and the reaction pressure was maintained at 4500 kPa by adding vinylidene fluoride as needed. When the amount of VDF consumed reached the desired level, the VDF feed was stopped. For a period of 30 minutes, agitation was continued and temperature was maintained. Then the agitation and heating were discontinued. After cooling to room temperature, surplus gas was vented and latex produced by reaction was drained into a suitable receiving vessel. Gravimetric solids measurement of the latex were done. The latex was coagulated by convention methods including freezing or directly dried by convection oven at 110 C.

The particle size of the dispersion was determined using a Nicomp Model 380 Sub-Micron Particle Sizer including single mode 35 mW Laser diode with wavelength of 639 nm.

Melt viscosity measurements of resin were performed with a DYNISCO LCR-7000 according to ASTM D3835 by a capillary rheometry at 232° C. and 100 sec'.

Thermal characteristics were measured according to ASTM standard D3418 using a TA Instruments DSC Q2000 with a LNCS, running at a cycle of 10° C. min from −20° C. to 210° C.

Solid content as measured by gravimetry.

Reverse units was measured using NMR. A ¹⁹F-NMR spectrum of the polymer powder was recorded by Bruker AVIII HD 500 Spectrometer using DMSO-d₆ as a solvent. The intensity of peak(s) (an integral value) at range of 91-92 ppm assigned to the fluorine atoms present in the isoregic units, while intensity of peak(s) at range of 112-116 ppm assigned to the fluorine atoms in the reverse units.

X-ray diffraction experiments were conducted on the Rigaku SmartLab diffraction platform (Cu Kα 1.5418 Å, 40 kV, 40 mA). Samples are loaded on a low background holder for WAXS analysis in reflection mode. The diffractometer used for WAXS analysis is a Rigaku SmartLab equipped with a copper X-ray tube (Cu Kα 1.5418 Å) set at 40 kV and 40 mA with a line focus (X-ray beam is used in line focus, with dimension of 12 mm long and 1 mm wide). The experiments are conducted in theta-theta (reflection) geometry with parallel beam optics (curved parabolic multi-layer mirror, turning a naturally divergent X-ray beam into a parallel X-ray beam with very low divergence). The incident slit is set at 1 mm aperture, the length-limiting slit at 10 mm aperture, and the two receiving slits at 3 mm aperture. The detector is a Rigaku Hypix 3000 used in 1D mode. Data are collected from 5.0° to 80.0° 2θin continuous mode, with a step of 0.02°, and scanning speed of 0.5° /min. The ratio of β-PVDF to α-PVDF and/or γ-PVDF was calculated as intensity ratio. The sum of β-PVDF (200) and β-PVDF (110) is divided by the sum of α-PVDF (020) and γ-PVDF (020).

Control is a PVDF homopolymer made by a typical emulsion polymerization using persulfate as the initiator and at a temperature above 75° C.

TABLE 1
Homopolymer-Surfactant free

| | React. | VDF | KPS | Bruggolite ® | | Particle |
|---|---|---|---|---|---|---|
| Example | Temp. | feed | usage | FF6M usage | Solids | size |
| number | (° C.) | (g) | (g) | (g) | (%) | (nm) |
| 1 | 23 | 332 | 0.72 | 1.03 | 13.6 | 396 |
| 2 | 33 | 332 | 1.05 | 1.1 | 19.2 | 373 |
| 3 | 43 | 332 | 1.37 | 1.2 | 17.6 | 402 |
| 4 | 53 | 332 | 1.23 | 0.8 | 18.6 | N/A |
| Control | | | | Not used | | |

TABLE 2

| | | | | | Intensity |
|---|---|---|---|---|---|
| | Melt | | | | ratio: |
| | Visc. | | | ΔH (J/g) | I_{β(200/110)}/ |
| Example | kP@100 | Reverse unit | | (1st | [I_{α(020)} + |
| number | S⁻¹ | (NMR, %) | Tₘ (° C.) | heating) | I_{γ(020)}] (1) |
| 1 | 46.6 | 3.4 | 177 | 83.3 | 54 |
| 2 | 39.6 | 3.5 | 177 | 75.7 | 70 |
| 3 | 52.8 | 3.7 | 175 | 71.4 | 62 |
| 4 | 60.8 | 4.0 | 172 | 72.4 | 79 |
| Control | 48-52 | 4.9-5.0 | 161-164 | 44-46 | 0 |

(1) Peak intensity ratio calculated using the sum of β (200) and β (110) observed around 20.6° 2θ with Cu Kα radiation, ratio to either the peak intensity of α (020) observed around 18.3° 20 with Cu Kα radiation, or the peak intensity of γ (020) observed around 18.3° 2θ with Cu Kα radiation, or the sum of peak intensities of α (020) and γ (020) if both polymorphs were present.

Experiments 1-4 shows that using the invention polymerization method β phase is obtained as evidenced by the intensity ratio and high delta H. In the typical emulsion (control) no β phase is present. Less reverse units are obtained with the novel polymerization method and while obtaining a high melting temperature as compared to the control.

Experiments 5-6: The experiments were carried out in a 2 gallon stainless steel reactor in which were added 6000 g of water. The reactor was purged with nitrogen gas. The reactor was sealed and agitation is started at 72 RPM. 72 RPM agitation was maintained throughout the whole reaction. The reactor was heated to desired temperature. The reactor was charged with vinylidene fluoride to reach the desired pressure of 4481 kPa (650 psi). After pressurization, the reactor was charged with initiator solution and a reducing agent solution. Initiator solution was aqueous initiator solution of 1% potassium persulfate (from EMD Chemicals, ACS grade). A reducing agent solution is 1% FF6M (Bruggolite) solution. A slug or continuous feed of the aqueous initiator solution and the reducing agent solution was added to the reaction to obtain adequate polymerization rate. Co monomer solution was fed to reactor right after the initiator solution and continually fed to reactor through the whole reaction. The reaction temperature was held and the reaction pressure was maintained at 4481 kPa (650 psi) by adding vinylidene fluoride as needed. When the amount of VDF consumed reached the desired level, the VDF feed was stopped. For a period of 30 minutes, agitation was continued and temperature was maintained. Then the agitation and heating were discontinued. After cooling to room temperature, surplus gas was vented and latex produced by reaction was drained into a suitable receiving vessel. Gravimetric solids measurement of the latex were done. The latex was coagulated by convention methods including freezing or directly dried by convection oven at 110° C.

| | | | | | | | | | Comonomer % |
|---|---|---|---|---|---|---|---|---|---|
| | VDF | | Cocomonomer | React. | KPS | FF6M | | Particle | in |
| Example | feed | Comonomer | feed | Temp. | usage | usage | Solid | size | copolymer, |
| number | g | name | amount (g) | (° C.) | g | g | (%) | (nm) | by NMR) |
| 5 | 1202 | Acrylic | 3.71 | 43 | 8 | 2.49 | 15.7 | 400 | 0.15 |
| | | acid | | | | | | | |
| 6 | 1202 | Acrylic | 2.96 | 40 | 7 | 2.08 | 14.2 | 398 | — |
| | | acid | | | | | | | |

| | Melt | | | | |
|---|---|---|---|---|---|
| | Visc. | | | ΔH (J/g) | Intensity |
| Example | kP@100 | Reverse unit | | (1st | ratio: I_{β(200/110)}/ |
| number | S⁻¹ | (NMR, %) | Tₘ (° C.) | heating) | [I_{α(020)} + I_{γ(020)}]₍₂₎ |
| 5 | 43.7 | 3.8 | 177 | 70.4 | 57 |
| 6 | 47.0 | — | 177 | 71.1 | 46 |

Experiments 5 and 6 show similar results as in experiments 1-4. Namely, β phase, high melting temperature and high delta H is obtained as compared to the control.

### Examples 7-8 (VDF Based Fluorinated-Copolymer-Comparative Examples)

The experiments were carried out in a 1.7 L stainless steel reactor in which were added 1000 g of water. The reactor was purged with nitrogen gas. The reactor was sealed and agitation is started at 72 RPM. 72 RPM agitation was maintained throughout the whole reaction. The reactor was heated to desired temperature. The reactor was charged with vinylidene fluoride and co monomer to reach the desired pressure of 4481 kPa (650 psi). After pressurization, the reactor was charged with initiator solution and a reducing agent solution. Initiator solution was aqueous initiator solution of 1% potassium persulfate (from EMD Chemicals, ACS grade). A reducing agent solution is 1% FF6M (Bruggolite) solution. A continuous feed of the aqueous initiator solution and the reducing agent solution was added to the reaction to obtain adequate polymerization rate. The reaction temperature was held and the reaction pressure was maintained at 4481 kPa (650 psi) by adding vinylidene fluoride and co monomer as needed. When the amount of VDF consumed reached the desired level, the VDF feed was stopped. For a period of 30 minutes, agitation was continued and temperature was maintained. Then the agitation and heating were discontinued. After cooling to room temperature, surplus gas was vented and latex produced by reaction was drained into a suitable receiving vessel. Gravimetric solids measurement of the latex were done. The latex was coagulated by convention methods including freezing or directly dried by convection oven at 110° C.

| | | | | | | | | Comonomer % |
|---|---|---|---|---|---|---|---|---|
| | VDF | Cocomonomer | React. | KPS | FF6M | | Particle | in |
| Example | feed | feed | Temp. | usage | usage | Solid | size | copolymer, |
| number | g | amount (g) | (° C.) | g | g | (%) | (nm) | by NMR) |
| 7 | 249 | hexafluoro- | 63 | 1.63 | 0.66 | 15.6 | 291 | 7.2 |
| Comparative | | propylene | | | | | | |
| | | (HFP) | | | | | | |
| | | 36.4 | | | | | | |
| 8 | 250 | 2, 3, 3, 3- | 43 | 1.62 | 0.74 | 14.9 | 265 | 18.8 |
| Comparative | | tetrafluoro- | | | | | | |
| | | propene | | | | | | |
| | | (1234yf) | | | | | | |
| | | 62.6 | | | | | | |

| | Melt | | | | |
|---|---|---|---|---|---|
| | Visc. | | | ΔH (J/g) | Intensity |
| Example | kP@100 | Reverse unit | | (1st | ratio: I_{β(200/110)}/ |
| number | S⁻¹ | (NMR, %) | Tₘ (° C.) | heating) | [I_{α(020)} + I_{γ(020)}]₍₂₎ |
| 7 | 47.2 | — | 163 | 55.6 | 0 |
| 8 | 36.1 | — | 125 | — | 0 |

The melting temperature of Comparative 7 was 163° C. No β phase crystal was found.

The melting temperature of Comparative 8 was 125° C. No β phase crystal was found.

1. A polyvinylidene fluoride polymer comprising recurring units derived from at least 97 mol percent vinylidene fluoride, optionally from 0 to 3 mol % acrylic comonomer, in an aqueous emulsion wherein the polymer has a β phase crystal peak intensity ratio of greater than 10 and a heat of fusion of greater than 65 J/g and a melting temperature of between 170° C. and 180° C., upon the 1st heating process in DSC.

2. A method for the synthesis of a fluorinated polymer comprising recurring units derived from vinylidene fluoride, said method comprising polymerizing vinylidene fluoride monomer, optionally in the presence of at least one acrylic comonomer, in an aqueous emulsion in a temperature range of from 1 to 65° C., in the presence of a redox-initiating system comprising at least one inorganic initiator and at least one reducing agent having a sulfinic group and wherein the resulting polymer has a β phase crystal peak intensity ratio of greater than 10.

3. The method of claim 2 wherein the at least one reducing agent comprises the formula (I): 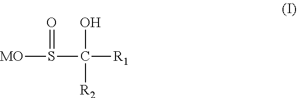
where; M is a hydrogen atom, an ammonium ion, a monovalent metal ion or an equivalent of a divalent metal ion of the groups Ia, IIa, IIb, IVa or VIIIb of the Periodic Table of the Elements; R1 is OH, wherein R2 is H, an alkyl group, an alkenyl group, a cycloalkyl or aryl group, optionally these groups have 1, 2 or 3 substituents which are chosen independently of one another from C₁-C₆ alkyl, OH, O—(C₁-C₆ alkyl), and R3 is COOM, SO3M, or COOR2, where M, and R2 are as defined above.

4. The method according to claim 3, wherein said inorganic initiator is selected from the group consisting of hydrogen peroxide, inorganic persulfates, and combinations thereof.

5. The method according to claim 2, wherein said inorganic initiator is used at a concentration ranging from 0.01 to 4 wt % based on the total VDF added to the reaction.

6. The method according to claim 2, wherein said inorganic initiator is selected from the group consisting of potassium persulfate, ammonium persulfate, sodium persulfate and combinations thereof.

7. The method according to claim 2, wherein the temperature range is from 5° C. to 60° C.

8. The method according to claim 4, wherein the temperature range is from 20° C. to 60° C.

9. The method according to claim 4, wherein said fluorinated polymer comprises at least 97 mole percent of recurring units derived from vinylidene fluoride with respect to all recurring units of said fluorinated polymer.

10. The method according to claim 9, wherein said fluorinated polymer is a homopolymer.

11. The method according to claim 9, wherein said fluorinated polymer is a co-polymer which comprises recurring units derived from vinylidene fluoride and recurring units derived from at least one acrylic comonomer.

12. The method according to claim 11, wherein the co monomer can be represented by the formula: 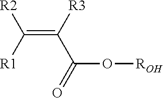
wherein each of R1, R2, R3, equal or different from each other, is independently a hydrogen atom or a C1-C3 hydrocarbon group, and ROH is a hydrogen or a C1-C5 hydrocarbon moiety.

13. The method according to claim 11, wherein at least one co monomer is selected from the group consisting of acrylic acid, methacrylic acid, hydroxyethyl(meth)acrylate, hydroxypropyl(meth)acrylate; and hydroxyethylhexyl(meth)acrylate.

14. The method according to claim 2, wherein the polymer β phase crystal peak intensity ratio is greater than 15.

15. The method according to claim 2, wherein the fluorinated polymer has a melting point of between 170 and 180 C.

16. The method according to claim 2, a wherein the fluorinated polymer has a heat of fusion of greater than 65 J/g upon the 1^{st} heating process in DSC.

17. The method according to claim 2, wherein the fluorinated polymer has reverse units percentage of between 3.2 to 4.2% as measure by ¹⁹F-NMR.

18. The method according to claim 2, wherein said reducer further comprises formula (II): 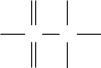
wherein M is a hydrogen atom, an ammonium ion, a monovalent metal ion; R₁ is —OH where R₂ is hydrogen atom, linear or branched alkyl group having from 1 to 6 carbon atoms, 5- or 6-membered cycloalkyl group, or 5- or 6-membered aryl group; R3 is —COOM, —SO₃M, or —COOR₂, wherein M, and R₂ are as defined above, and salt thereof with at least one monovalent metal ion;
Preferably, M is hydrogen atom or a monovalent metal ion;
Preferably, said monovalent metal ion is selected from sodium and potassium;
Preferably, R2 is selected from hydrogen atom, linear or branched alkyl group having from 1 to 3 carbon atoms, and 5- or 6-membered aryl group.

19. The polyvinylidene fluoride polymer of claim 1, wherein the polymer has a β phase crystal peak intensity ratio of greater than 30.

20. The polymer made by the method of claim 2.

21. (canceled)
